(19) United States
(12) Patent Application Publication
(10) Pub. No.: US 2023/0316697 A1
(43) Pub. Date: Oct. 5, 2023

(54) ASSOCIATION METHOD, ASSOCIATION SYSTEM, AND NON-TRANSITORY COMPUTER-READABLE STORAGE MEDIUM

(71) Applicant: BROTHER KOGYO KABUSHIKI KAISHA, Nagoya (JP)

(72) Inventor: Masaki KONDO, Toyoake (JP)

(21) Appl. No.: 18/331,511

(22) Filed: Jun. 8, 2023

Related U.S. Application Data
(63) Continuation of application No. PCT/JP2021/044428, filed on Dec. 3, 2021.

(30) Foreign Application Priority Data
Dec. 9, 2020 (JP) 2020-203995

(51) Int. Cl. G06V 10/25; G06F 3/04845

(52) U.S. Cl. CPC G06V 10/25; G06F 3/04845

(57) ABSTRACT

An association system associates information with image data used for training of a machine learning model. The association system has a processor that acquires target image data of a target image which is an image to be processed, analyzes the target image data to detect an object region indicating an image of an object of interest from within the target image, determines an extended region including the object region and a portion on an outer side of the object region, and associates annotation data, which indicates annotation information including region information indicating the extended region, with the target image data to be stored in a storage device.

### REFERENCE TO RELATED APPLICATIONS

This is a continuation application of International Application No. PCT/JP2021/044428 filed on Dec. 3, 2021 which claims priority from Japanese Patent Application No. 2020-203995 filed on Dec. 9, 2020. The entire contents of the earlier applications are incorporated herein by reference.

### BACKGROUND ART

A machine learning model for processing an image has been used. Image data and information related to the image data (also referred to as meta data) are used to train the machine learning model. The meta data indicates, for example, information related to an object in the image (a position of the object, a region indicating the object, identification information of the object, and the like). The information related to the image data is added by an operator. Addition of the information to the image data is also called annotation. It is disclosed to propose a technique for evaluating the accuracy of information added by an operator and causing the operator to process an image corresponding to the evaluation.

For appropriate training of the machine learning model, association of appropriate information is required. The appropriate information varies depending on the machine learning model to be trained. Under such circumstances, it is not easy to associate the appropriate information with image data.

### DESCRIPTION

The present disclosure discloses a technique of associating appropriate information with image data.

According to an aspect of the present disclosure, there is provided an association method of associating information with image data used for training of a machine learning model, including: acquiring target image data of a target image which is an image to be processed; analyzing the target image data to detect an object region indicating an image of an object of interest from within the target image; determining an extended region including the object region and a portion on an outer side of the object region; and associating annotation data, which indicates annotation information including region information indicating the extended region, with the target image data to be stored in a storage device.

According to the aspect, since the annotation information including the region information indicating the extended region, which includes the object region detected by analyzing the target image data and the portion on the outer side of the object region, is associated with the target image data to be stored in the storage device, a region including another region in addition to the region indicating the object of interest can be associated with the target image data.

The technique disclosed in the present disclosure can be realized in various modes, and can be realized in a form of, for example, a method of specifying information to be associated with image data and a specifying device, an association method of associating information with image data and an association device, a method of generating learning image data and a generation device, a computer program for realizing a function of the methods or the devices, a recording medium (for example, a non-transitory computer-readable storage medium) in which the computer program is recorded, and the like.

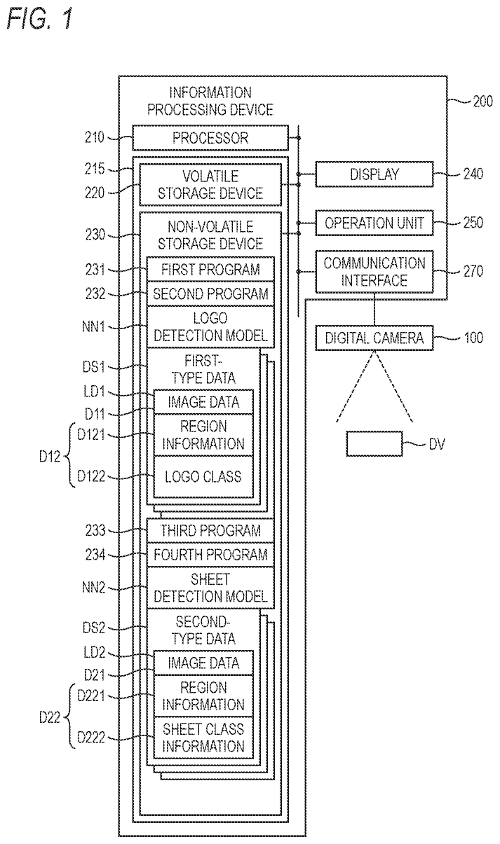

FIG. 1 is an explanatory diagram illustrating an information processing device.

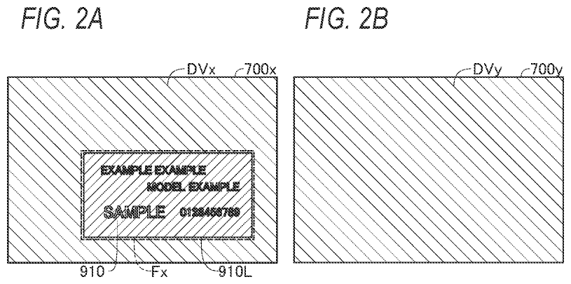

FIGS. 2A and 2B are schematic diagrams illustrating examples of captured images.

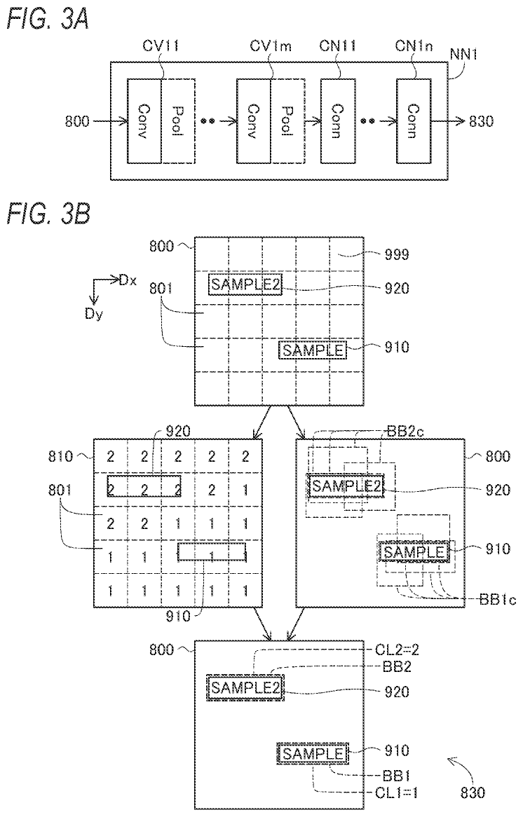

FIG. 3A is a schematic diagram illustrating an example of a configuration of a logo detection model NN1. FIG. 3B is a schematic diagram illustrating an outline of an operation of the logo detection model NN1.

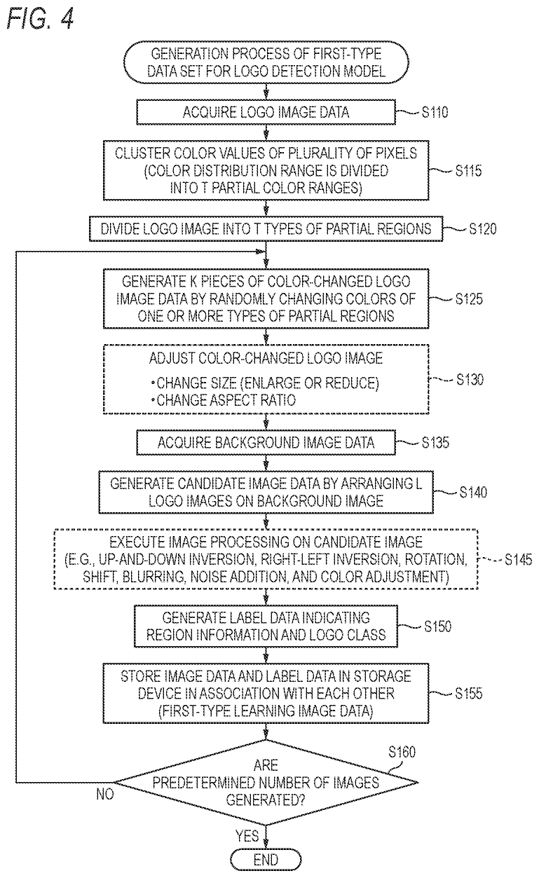

FIG. 4 is a flowchart illustrating an example of a generation process of a first-type data set DS1.

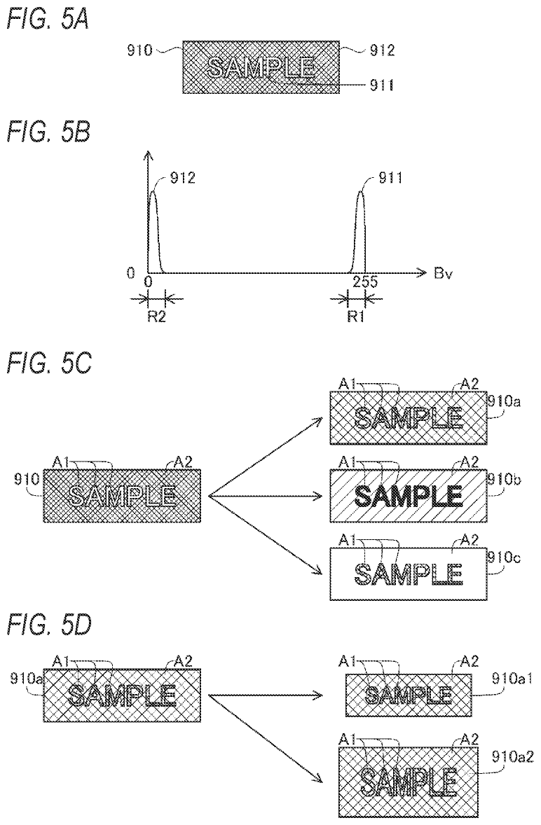

FIG. 5A is an explanatory diagram illustrating an example of a logo image. FIG. 5B is a histogram showing an example of a distribution range of color values. FIG. 5C is an explanatory diagram illustrating divided partial regions. FIG. 5D is an explanatory diagram illustrating an example of a color-changed logo image generated by an additional adjustment process.

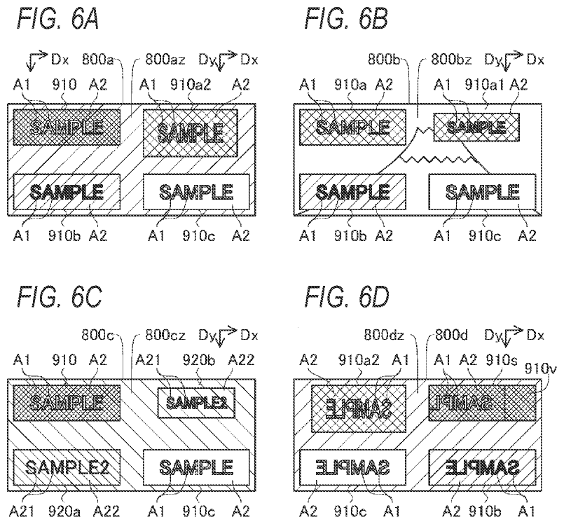

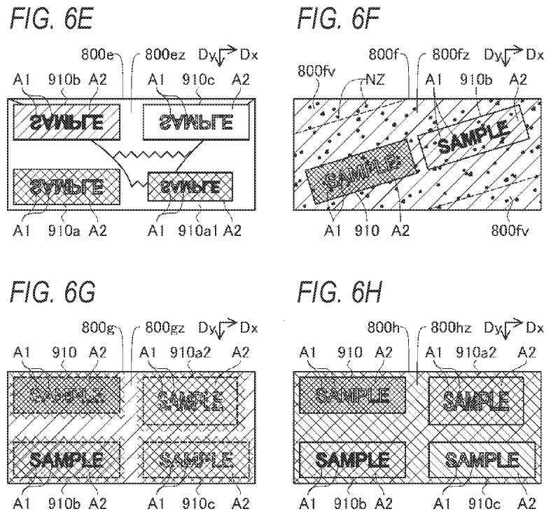

FIGS. 6A to 6H are schematic diagrams illustrating examples of candidate images.

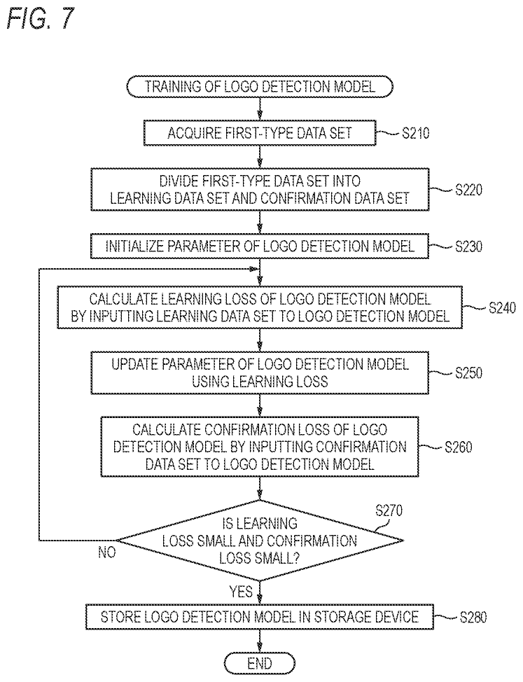

FIG. 7 is a flowchart illustrating an example of a training process of the logo detection model NN1.

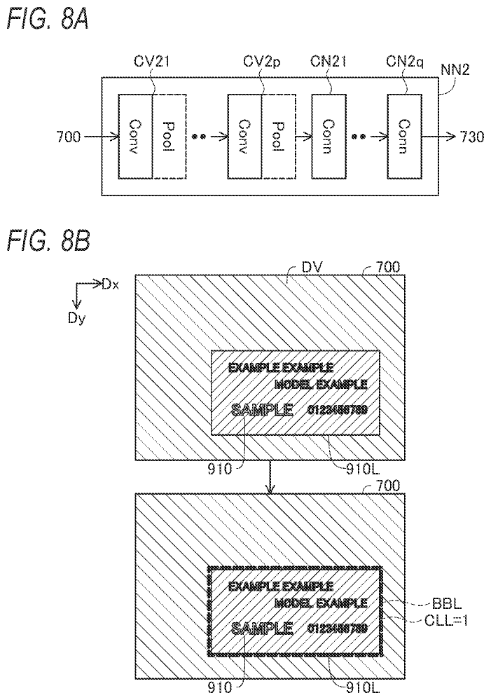

FIG. 8A is a schematic diagram illustrating an example of a configuration of a sheet detection model NN2. FIG. 8B is an explanatory diagram illustrating an outline of an operation of the sheet detection model NN2.

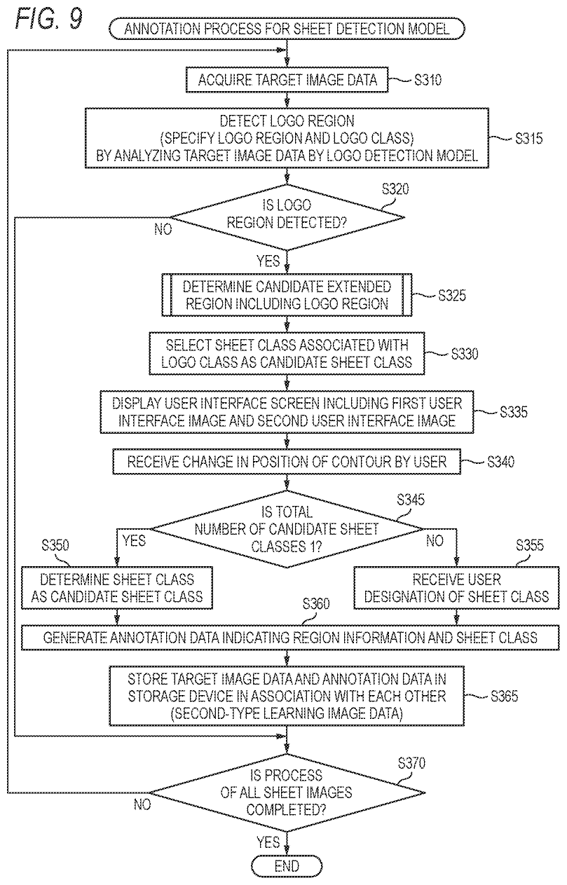

FIG. 9 is a flowchart illustrating an example of a generation process of a second-type data set DS2.

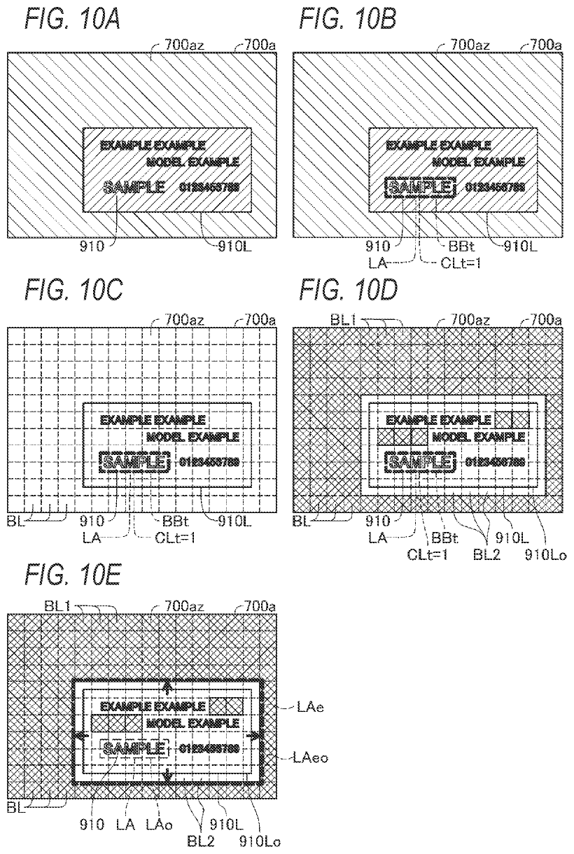

FIG. 10A is an explanatory diagram illustrating an example of a target image. FIG. 10B is an explanatory diagram illustrating an example of a logo region. FIG. 10C is an explanatory diagram illustrating an example of a plurality of blocks. FIG. 10D is an explanatory diagram illustrating an example of a uniform block. FIG. 10E is an explanatory diagram illustrating an example of candidates for an extended region.

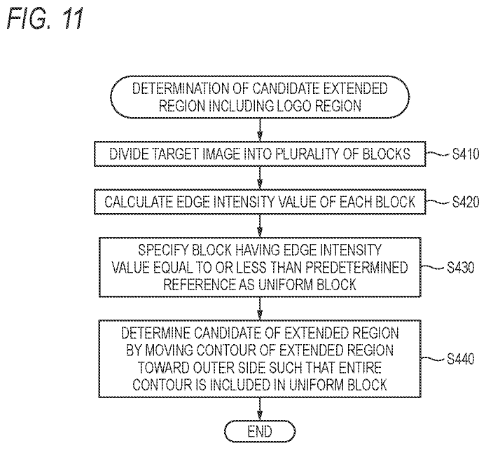

FIG. 11 is a flowchart illustrating an example of a process of determining the candidates of the extended region.

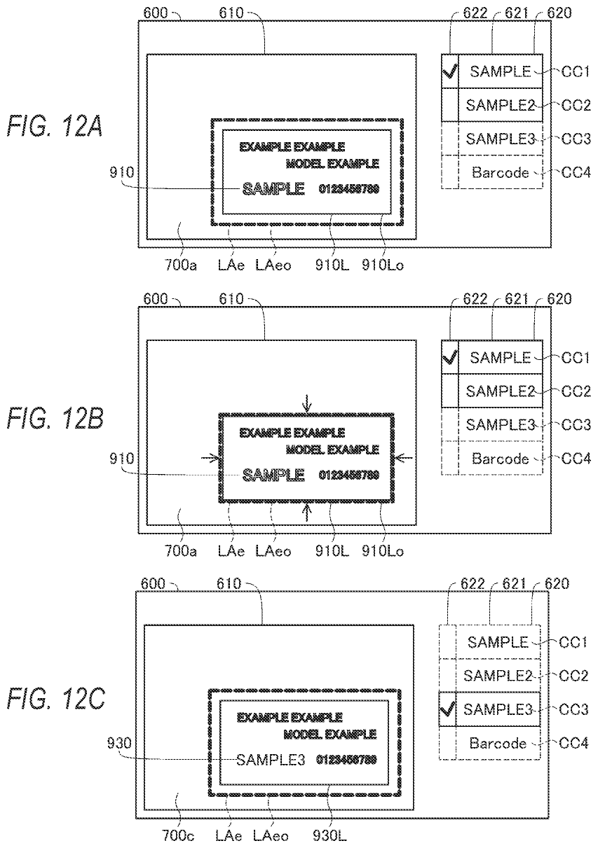

FIG. 12A is an explanatory diagram illustrating an example of a UI screen. FIG. 12B is an explanatory diagram illustrating an example of a changed contour LAeo. FIG. 12C is an explanatory diagram illustrating an example of the UI screen.

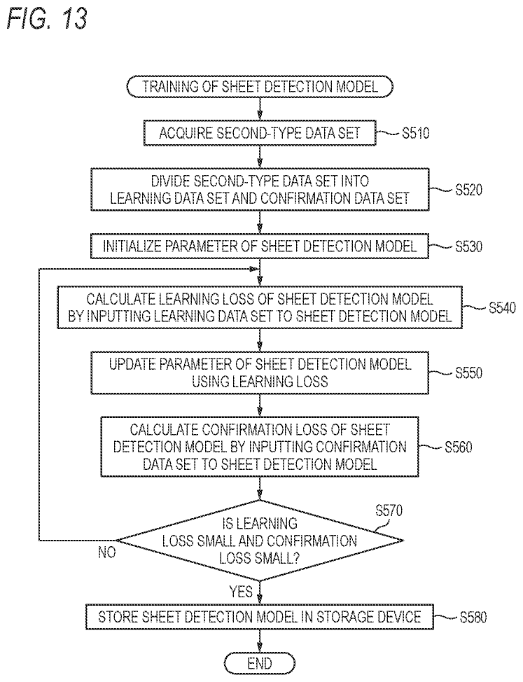

FIG. 13 is a flowchart illustrating an example of a training process of the sheet detection model NN2.

### A. FIRST EMBODIMENT

A1. Device Configuration:

FIG. 1 is an explanatory diagram illustrating an information processing device according to an embodiment. In the present embodiment, an information processing device 200 is, for example, a personal computer. The information processing device 200 executes various processes for training a machine learning model used for inspecting an object (for example, a product such as a printer). The information processing device 200 includes a processor 210, a storage device 215, a display 240, an operation unit 250, and a communication interface 270. These elements are connected to each other via a bus. The storage device 215 includes a volatile storage device 220 and a non-volatile storage device 230.

The processor 210 is a device implemented to execute data processing, and is, for example, a CPU. The volatile storage device 220 is, for example, a DRAM, and the non-volatile storage device 230 is, for example, a flash memory. The non-volatile storage device 230 stores programs 231, 232, 233, and 234, a logo detection model NN1, a first-type data set DS1 for training the logo detection model NN1, a sheet detection model NN2, and a second-type data set DS2 for training the sheet detection model NN2. The models NN1 and NN2 are so-called machine learning models, and are program modules in the present embodiment. Details of the programs 231 to 234, the models NN1 and NN2, and the data sets DS1 and DS2 will be described later.

The display 240 is a device implemented to display an image, such as a liquid crystal display or an organic EL display. The operation unit 250 is a device implemented to receive an operation by a user, such as a button, a lever, or a touch panel disposed on the display 240 in an overlapping manner. The user can input various requests and instructions to the information processing device 200 by operating the operation unit 250. The communication interface 270 is an interface for communicating with another device (for example, a USB interface, a wired LAN interface, or a wireless interface of IEEE802.11). A digital camera 100 is connected to the communication interface 270. The digital camera 100 generates image data of a captured image by capturing an object DV to be inspected. Hereinafter, it is assumed that the object DV is a printer (the object DV is also referred to as a printer DV).

A2. Captured Image:

FIGS. 2A and 2B are schematic diagrams illustrating examples of captured images. A first captured image 700x in FIG. 2A indicates a first printer DVx having no failure. A label sheet 910L (also simply referred to as a sheet 910L) is attached to the first printer DVx. The first captured image 700x includes an image of the sheet 910L. A second captured image 700y in FIG. 2B indicates a second printer DVy having a failure. The sheet 910L is not attached to the second printer DVy, and the second captured image 700y does not include the image of the sheet 910L. Hereinafter, whether an appropriate label sheet is attached to the printer is inspected.

In the present embodiment, the sheet 910L includes a logo image 910. The logo image 910 indicates a character string “SAMPLE”. In addition, the sheet 910L includes other regions (for example, regions indicating images of other character strings) in addition to a region of the logo image 910. A logo is not limited to a character string, and may be various images such as a graphic, a mark, and a symbol. The sheet 910L may be implemented using various types of elements (for example, graphics, patterns, photographs, and the like), not limited to a character string.

The sheet detection model NN2 (FIG. 1) is a machine learning model for detecting an image of a label sheet (for example, sheet 910L) from a captured image of a printer using captured image data that is image data indicating the captured image. When the image of the label sheet is detected, an inspection result of the printer is acceptable. When no image of the label sheet is detected, the inspection result of the printer is unacceptable.

Image data of various images including the image of the sheet is used for the training of the sheet detection model NN2. Various kinds of information are associated with data (here, image data) used for the training. A process of associating information with data is also referred to as annotation or labeling. Hereinafter, the information associated by the annotation is also referred to as annotation information. In the present embodiment, the annotation information includes region information for specifying a region indicating a sheet to be detected. For example, when the image data of the first captured image 700x in FIG. 2A is used for the training, the annotation information includes region information indicating a frame Fx surrounding the sheet 910L.

The annotation information is usually determined by an operator. For example, the operator determines the frame Fx surrounding the sheet 910L by observing the first captured image 700x. In addition, various image data are used for the training. For example, display modes of the sheet such as a sheet position, a sheet color, and a sheet size may be different among a plurality of image data. It is not easy for the operator to determine appropriate annotation information for each of the various image data. For example, the operator may determine an inappropriate frame surrounding only a part of the sheet 910L. Therefore, in the present embodiment, the information processing device 200 (FIG. 1) detects a logo image (for example, the logo image 910) from the image for training using the logo detection model NN1. Then, the information processing device 200 determines an extended region including a logo region that is a region indicating the logo image and a portion on an outer side of the logo region. The extended region can appropriately indicate the sheet (for example, the sheet 910L). Then, the information processing device 200 associates annotation information including region information indicating the extended region with the image data. Hereinafter, the logo detection model NN1 and the sheet detection model NN2 will be described in this order.

A3. Configuration of Logo Detection Model NN1:

FIG. 3A is a schematic diagram illustrating an example of a configuration of the logo detection model NN1. In the present embodiment, the logo detection model NN1 is an object detection model referred to as you only look once (YOLO). The YOLO is disclosed in, for example, a paper of “Joseph Redmon, Santosh Divvala, Ross Girshick, Ali Farhadi, “You Only Look Once: Unified, Real-Time Object Detection”, Proceedings of the IEEE Conference on Computer Vision and Pattern Recognition (CVPR), 2016, pp. 779-788″. The YOLO model predicts a frame including an object called a bounding box, a certainty factor indicating that the box includes objects, and a probability (also referred to as a class probability) for each type of object when the box includes objects, using a convolution neural network.

As illustrated in FIG. 3A, the logo detection model NN1 includes m (m is an integer of 1 or more) convolution layers CV11 to CV1m and n (n is an integer of 1 or more) fully connected layers CN11 to CN1n following the convolution layers CV11 to CV1m (m is, for example, 24. n is, for example, 2.). A pooling layer is provided immediately after one or more convolution layers among the m convolution layers CV11 to CV1m.

The convolution layers CV11 to CV1m execute a process including a convolution process and a bias addition process on input data. The convolution process is a process of sequentially applying s filters of (p×q×r) dimensions to the input data and calculating a correlation value indicating a correlation between the input data and the filters (p, q, r, and s are integers of 1 or more).

In the process of applying each filter, a plurality of correlation values are sequentially calculated while sliding the filter. One filter includes (p×q×r) weights. The bias addition process is a process of adding a bias to the calculated correlation value. One bias is prepared for each filter. The dimensions (p×q×r) of the filters and the number s of the filters are usually different among the m convolution layers CV11 to CV1m. The convolution layers CV11 to CV1m each have a parameter set including a plurality of weights and a plurality of biases of a plurality of filters.

The pooling layer executes a process of reducing the number of dimensions of data for data input from the immediately preceding convolution layer. As a process for pooling, various kinds of processes such as average pooling and max pooling can be used. In the present embodiment, the pooling layer executes the max pooling. In the max pooling, the number of dimensions is reduced by selecting a maximum value in a window of a predetermined size (for example, 2×2) while sliding the window by a predetermined stride (for example, 2).

The fully connected layers CN11 to CN1n output g-dimensional data (that is, g values. g is an integer of 2 or more.) using f-dimensional data (that is, f values. f is an integer of 2 or more.) input from the immediately preceding layer. Each of the output g values is a value (inner product+bias) obtained by adding a bias to an inner product of a vector including the input f values and a vector including f weights. The convolution layers CV11 to CV1m output the g-dimensional data using (f×g) weights and g biases. The number f of dimensions of input data and the number g of dimensions of output data are usually different among the n fully connected layers CN11 to CN1n. Each of the fully connected layers CN11 to CN1n has a parameter set including a plurality of weights and a plurality of biases.

Data generated by each of the convolution layers CV11 to CV1m and the fully connected layers CN11 to CN1n is input to an activation function and converted. As the activation function, various functions can be used. In the present embodiment, a linear activation function is used for the last layer (here, the fully connected layer CN1n), and leaky rectified linear units (LReLU) are used for other layers.

FIG. 3B is a schematic diagram illustrating an outline of an operation of the logo detection model NN1. An image 800 is an example of an input image input to the logo detection model NN1. The input image 800 is represented by respective color values of a plurality of pixels arranged in a matrix along a first direction Dx and a second direction Dy perpendicular to the first direction Dx. In the present embodiment, the color values are represented by three component values of R (red), G (green), and B (blue). In the example in FIG. 3B, the input image 800 illustrates two types of logo images 910 and 920. In the present embodiment, a first logo image 910 is an image of a character string “SAMPLE”. A second logo image 920 is a logo image different from the first logo image 910, and is an image of a character string “SAMPLE2”.

The logo detection model NN1 divides the input image 800 into S×S grid cells 801 (also simply referred to as cells 801) (S is an integer of 2 or more. S is, for example, 5.). A center of each of the logo images 910 and 920 is included in any one of the cells 801. Detection results of the logo images 910 and 920 (more generally, objects) are indicated by predicted values associated with the cells 801 including centers of object regions (details will be described later).

Each cell 801 is associated with Bn rectangular bounding boxes (Bn is an integer of 1 or more. Bn is, for example, 2.). A right portion of the middle part in FIG. 3B illustrates, as an example of the bounding box, a plurality of first-type bounding boxes BB1c associated with the first logo image 910 and a plurality of second-type bounding boxes BB2c associated with the second logo image 920. The following five predicted values are associated with each of the bounding boxes. That are, a center position x in the first direction Dx with respect to the cell 801, a center position y in the second direction Dy with respect to the cell 801, a width w in the first direction Dx, a height h in the second direction Dy, and a certainty factor. When the center of the object region is not included in the cell 801, it is expected that the certainty factor of the bounding box associated with the cell 801 is zero. When the center of the object region is included in the cell 801, it is expected that the certainty factor of the bounding box associated with the cell 801 is high. Specifically, the certainty factor is expected to be the same as intersection over union (IOU) between the region of the bounding box and the object region. Here, IOU is a ratio obtained by dividing an area of a common portion of two regions by an area of a region of a union of the two regions. Such a certainty factor indicates a degree of matching between the bounding box and the object region. The certainty factor is calculated independently of the type of the object.

Here, it is assumed that the logo detection model NN1 detects C types of logo images (C is an integer of 1 or more. C is, for example, 3.). The type of the logo image is also referred to as a class or a logo class. Each cell 801 is further associated with C class probabilities. The C class probabilities correspond to C types of objects (here, logo images), respectively. The class probability is a probability under a condition that the center of the object region is included in the cell 801, and indicates a probability for each type of object. Regardless of the total number Bn of the bounding boxes associated with one cell 801, C class probabilities are associated with one cell 801. A left portion of the middle part in FIG. 3B illustrates a class probability map. The class probability map indicates a class identifier specified for each cell 801 and corresponding to the highest class probability. As illustrated, in the cells 801 close to the first logo image 910, the probability of a class identifier of “1”, which is the type of the first logo image 910, is high. In the cells 801 close to the second logo image 920, the probability of a class identifier of “2”, which is the type of the second logo image 920, is high. The plurality of first-type bounding boxes BB1c on the right portion in the drawing are bounding boxes associated with the cells 801 indicating the class identifier of “1” on the class probability map. The plurality of second-type bounding boxes BB2c are bounding boxes associated with the cells 801 indicating the class identifier of “2” on the class probability map.

The logo detection model NN1 (FIG. 3A) outputs output data 830 indicating S×S×(Bn×5+C) predicted values. Among S×S×Bn bounding boxes, a bounding box having a certainty factor equal to or higher than a threshold is adopted as a box (referred to as an object box) indicating a detected object (here, logo image). The class identifier corresponding to the highest class probability among the C class probabilities corresponding to the object box is adopted as a class identifier associated with the object box. As illustrated in the right portion of the middle part in FIG. 3B, a plurality of bounding boxes overlapping one logo image may be candidates for the object box. In order to select one bounding box from the plurality of mutually overlapping bounding boxes, a process called “Non-maximal suppression” may be executed. This process is a process of deleting one box (for example, a box having a lower certainty factor) when the IOU between two boxes is equal to or greater than a reference. By repeating this process, one object box corresponding to one logo image is detected. For example, as illustrated in a lower part in FIG. 3B, a first object box BB1 (class identifier CL1=1) indicating the first logo image 910 and a second object box BB2 (class identifier CL2=2) indicating the second logo image 920 are detected.

A4. Generation Process of First-Type Data Set DS1:

FIG. 4 is a flowchart illustrating an example of a generation process of the first-type data set DS1 for the training of the logo detection model NN1. The processor 210 (FIG. 1) executes the process in FIG. 4 in accordance with a first program 231.

In S110, the processor 210 acquires logo image data which is image data of the logo image. In the present embodiment, the logo image data is bitmap data of RGB and is stored in advance in the non-volatile storage device 230 (not illustrated). FIG. 5A is an explanatory diagram illustrating an example of the logo image. The first logo image 910 is illustrated in the drawing. The first logo image 910 includes a character region 911 and a background region 912. A plurality of pixels in the character region 911 have substantially the same color, and a plurality of pixels in the background region 912 have substantially the same color. The logo image data may be data generated using an image editing application program. Alternatively, the logo image data may be data generated by reading a logo sample with a scanner (not illustrated). In the present embodiment, the processor 210 acquires data of a plurality of logo images including data of the first logo image 910, data of the second logo image 920 (FIG. 3B), and data of a third logo image (not illustrated). Although not illustrated, each of the second logo image 920 and the third logo image includes a character region indicating a plurality of characters and a background region similarly to the first logo image 910.

In S115 (FIG. 4), the processor 210 clusters color values of a plurality of pixels of the logo image. As a result, a distribution range of the color values of the logo image is divided into T (T is an integer of 2 or more) partial color ranges.

FIG. 5B is a histogram illustrating an example of the distribution range of the color values. The horizontal axis represents a luminance value By. A range of the luminance value By is divided into a plurality of sections. The vertical axis indicates the number of pixels in each section. This histogram shows a distribution of the luminance values By of the first logo image 910 (FIG. 5A). A bright first partial color range R1 indicates a distribution range of the luminance values By in the character region 911, and a dark second partial color range R2 indicates a distribution range of the luminance values By in the background region 912. The processor 210 calculates the luminance values By based on the color values of RGB of the plurality of pixels, and generates a histogram of the luminance values By. When a plurality of sections having one or more pixels are continuous, the processor 210 specifies a range indicated by the plurality of continuous sections as one cluster (that is, a partial color range). In the example in FIG. 5B, the two partial color ranges R1 and R2 are specified.

In S120 (FIG. 4), the processor 210 divides the logo image into T types of partial regions corresponding to the T partial color ranges. FIG. 5C is an explanatory diagram illustrating the divided partial regions. As illustrated in a left portion in FIG. 5C, the logo image 910 is divided into a first-type region A1 and a second-type region A2. The first-type region A1 corresponds to the first partial color range R1, that is, the character region 911, and the second-type region A2 corresponds to the second partial color range R2, that is, the background region 912. One type of partial region corresponding to one partial color range may include a plurality of regions separated from each other as in the first-type region A1. Although not illustrated, other logo images are also divided into a plurality of regions by S115 and S120.

By S115 and S120, the logo image is divided into T types of partial regions having similar colors. A method for dividing the distribution range of the color values into T partial color ranges may include various methods for associating a plurality of pixels having similar colors with one partial color range. For example, a range of the luminance value By may be divided by a luminance value By corresponding to a valley of the histogram. In addition, the distribution range of the color values may be divided into T partial color ranges by using various color components (for example, hue, chroma, and the like), not limited to the luminance values By. Further, various clustering algorithms such as k-means clustering may be used. The total number T of partial color ranges (that is, the number T of types of partial regions) is determined for each logo image. Alternatively, T may be determined in advance.

In S125, the processor 210 generates K pieces of color-changed logo image data (K is an integer of 1 or more) by executing an adjustment process of randomly changing the colors of one or more types of partial regions. In a right portion in FIG. 5C, three color-changed logo images 910a, 910b, and 910c are illustrated as examples of color-changed logo images generated from the first logo image 910. Between the color-changed logo images 910a, 910b, and 910c and the original logo image 910, colors of any one of the first-type region A1 and the second-type region A2 or colors of both the regions are different. Although not illustrated, the processor 210 also generates a color-changed logo image from another logo image.

In the present embodiment, the processor 210 changes a color of the entire of one type of partial region to the same color that is randomly determined. For example, when the color of the first-type region A1 is changed, all of the colors of the plurality of characters included in the first-type region A1 are changed to the same color.

The color after change may be a color close to the color before the change. For example, when each color value of RGB is represented by a value in a range of 0 to 255, a process for color change may be a process of adding a random number value in a range of −100 to +100 to the color value of each color component.

The processor 210 randomly determines the total number of color-changed logo image data to be generated for each logo image. Alternatively, the total number of color-changed logo image data to be generated may be determined in advance for each logo image.

In S130, the processor 210 executes an additional adjustment process of the color-changed logo image data. The additional adjustment process includes any one or both of a size change process and an aspect ratio change process. The size change process may be either an enlargement process or a reduction process. FIG. 5D is an explanatory diagram illustrating an example of a color-changed logo image generated by the additional adjustment process. The drawing illustrates two color-changed logo images 910a1 and 910a2 generated from the color-changed logo image 910a. A first color-changed logo image 910a1 is an image generated by the size change process (here, the reduction process). A second color-changed logo image 910a2 is an image generated by the aspect ratio change process. The processor 210 also executes the additional adjustment process on a color-changed logo image generated from another logo image. The processor 210 randomly determines whether to execute the additional adjustment process, a color-changed logo image to be subjected to the additional adjustment process, and a content of the additional adjustment process.

In S135, the processor 210 acquires background image data. The background image data is image data indicating a background image on which a logo image is to be arranged. In the present embodiment, the processor 210 randomly acquires background image data to be processed from a plurality of background image data (not illustrated) prepared in advance. The plurality of background image data are stored in advance in the storage device 215 (for example, the non-volatile storage device 230) (not illustrated). The plurality of background image data include data of a background image representing a monochromatic solid image and data of a background image of a photograph. The monochromatic solid image is an image including a plurality of pixels having the same color. In the present embodiment, any background image is a rectangular image surrounded by two sides parallel to the first direction Dx and two sides parallel to the second direction Dy.

In S140, the processor 210 generates candidate image data by arranging L (L is an integer of 1 or more) logo images on the background image. The processor 210 selects the L logo images from a plurality of logo images including the logo image acquired in S110, the color-changed logo image generated in S125, and the color-changed logo image generated in S130. The processor 210 randomly determines positions of respective logo images on the background image. Alternatively, the processor 210 may arrange the logo images at predetermined positions on the background image. In either case, the processor 210 determines the positions of the respective logo images such that the plurality of logo images do not overlap each other. The total number L of the logo images is determined to be a value within a range of not less than 1 and not more than the maximum number of logo images that can be arranged on the background image. For example, the processor 210 randomly determines L and randomly selects L logo images.

FIGS. 6A to 6H are schematic diagrams illustrating examples of candidate images. Three candidate images 800a to 800c in FIGS. 6A to 6C include background images 800az, 800bz, and 800cz and four logo images arranged on each of the background images 800az, 800bz, and 800cz. Main features of the candidate images 800a to 800c are as follows. (I1) Candidate image 800a: the background image 800az is a monochromatic solid image. (I2) Candidate image 800b: the background image 800bz is an image of a photograph.
(I3) Candidate image 800c: the logo images 910 and 910c obtained from the first logo image 910 and logo images 920a and 920b obtained from the second logo image 920 are included.

As indicated by the logo images 920a and 920b in FIG. 6C, the second logo image 920 is divided into a first-type region A21 and a second-type region A22. The logo image 920a is an image generated by changing the color of the second logo image 920. The logo image 920b is an image generated by the color change and the reduction process of the second logo image 920.

In S145 (FIG. 4), the processor 210 generates new candidate image data by executing image processing on the candidate image data. The image processing includes one or more processes selected from a group consisting of the following seven processes P1 to P7.
(P1) An up-and-down inversion process of vertically inverting a candidate image
(P2) A right-left inversion process of horizontally inverting a candidate image
(P3) A rotation process of rotating a candidate image
(P4) A shift process of translating a portion indicated within a region in a color-changed object image without changing a region indicating a color-changed object image in a candidate image
(P5) A blurring process of blurring a candidate image
(P6) A noise addition process of adding a noise to a candidate image
(P7) A color adjustment process of adjusting a color of a candidate image

Five candidate images 800d to 800h in FIGS. 6D to 6H are examples of candidate images generated by the image processing in S145. The candidate image 800f in FIG. 6F includes a background image 800fz and two logo images 910 and 910b arranged on the background image 800fz. The other candidate images 800d, 800e, 800g, and 800h include background images 800dz, 800ez, 800gz, and 800hz and four logo images arranged on each of the background images. Main features of the candidate images 800d to 800h are as follows.
(I4) Candidate image 800d: the background image 800dz is a monochromatic solid image, a right-left inversion process is executed, and a logo image 910s is generated by the shift process.
(I5) Candidate image 800e: the background image 800ez is an image of a photograph, and an up-and-down inversion process is executed.
(I6) Candidate image 800f: a rotation process and a noise addition process of adding a noise NZ are executed.
(I7) Candidate image 800g: a blurring process is executed.
(I8) Candidate image 800h: a color adjustment process is executed.

In the present embodiment, the first direction Dx (FIG. 6D) indicates a right direction. Accordingly, the right-left inversion process inverts a position in the first direction Dx. The second direction Dy (FIG. 6E) indicates a downward direction. Accordingly, the up-and-down inversion process reverses a position in the second direction Dy.

The shift process (FIG. 6D) causes an original logo image to translate to the left in an original region of the logo image 910s. A portion of the logo image after the movement that protrudes outside the original region of the logo image 910s is deleted. For example, a part on a left side of the first-type region A1 is deleted. In the original region of the logo image 910s, a color of a blank portion 910v generated by the translation of the original logo image is set to the same color as the color of the second-type region A2 indicating the background region. The processor 210 randomly determines a movement direction and a movement amount under the shift process.

In the rotation process (FIG. 6F), an original candidate image is rotated counterclockwise in an original region of the candidate image 800f A portion of the candidate image after the rotation that protrudes outside the original region of the candidate image 800f is deleted. In the original region of the candidate image 800f, a copy of a part of the background image 800fz is assigned to a blank portion 800fv generated by the rotation of the original candidate image. The processor 210 randomly determines a rotation center, a rotation direction, and a rotation angle.

In the noise addition process (FIG. 6F), a plurality of target pixels are randomly selected from a plurality of pixels of the candidate image 800f, and a random number value is added to each color value of the plurality of target pixels. The noise addition process may be any of various other processes. For example, a random number value may be added to all pixels of the candidate image. A noise image prepared in advance may be superimposed on the candidate image.

The blurring process (FIG. 6G) is also referred to as a smoothing process. In the present embodiment, the blurring process is a process using an average value filter, and the entire of the candidate image 800g is processed. The blurring process may be various processes of smoothing the color values (for example, other smoothing filters such as a median filter and a gaussian filter may be used).

In the present embodiment, the color adjustment process (FIG. 6H) is a gamma correction process of reducing a luminance value, and the entire of the candidate image 800h is processed. The color adjustment process may be any process of adjusting a color of a candidate image (for example, a gamma correction process of increasing a luminance value, a contrast enhancement process, a chroma adjustment process, a white balance adjustment process, and the like).

The processor 210 randomly determines whether to execute the image processing in S145, a candidate image to be subjected to the image processing, and the content of the image processing. For example, the process to be executed is randomly selected from the seven processes P1 to P7.

In S150 (FIG. 4), the processor 210 randomly selects Z (Z is an integer of 1 or more) pieces of first-type learning image data D11 to be included in the first-type data set DS1 (FIG. 1) from a plurality of candidate image data including the candidate image data generated in S140 and the candidate image data generated in S145 (the number Z is also randomly determined). Then, the processor 210 generates Z pieces of label data D12 corresponding to the Z pieces of first-type learning image data D11. In the present embodiment, the label data D12 is data that defines a target value (that is, a correct answer) of the output data 830 of the logo detection model NN1 (FIG. 3A). Such label data D12 is also called labeled data. Specifically, the label data D12 indicates region information D121 indicating a region of the logo image in the candidate image and a logo class D122 indicating a type of the logo image. The region information D121 indicates a center position of the region in the candidate image (specifically, a position in the first direction Dx and a position in the second direction Dy), a width in the first direction Dx, and a height in the second direction Dy. In the present embodiment, the logo image is classified into C classes. The logo class D122 indicates any one of the C classes.

The processor 210 specifies a combination of the region information D121 and the logo class D122 of each of the L logo images in the candidate image based on contents of the processes in S125 to S145. The region information D121 is determined to indicate a minimum rectangle including the entire logo image. When the candidate image includes the L logo images, the processor 210 generates the label data D12 indicating L combinations of the region information D121 and the logo class D122.

In S155, the processor 210 associates the first-type learning image data D11 (FIG. 1) with the label data D12 and stores the data in the storage device 215 (for example, the non-volatile storage device 230). Hereinafter, the entire of the first-type learning image data D11 and the label data D12 associated with each other is also referred to as first-type labeled data LD1. The first-type data set DS1 includes a plurality of first-type labeled data LD1. The processor 210 may store the labeled data LD1 in an external storage device (not illustrated) connected to the information processing device 200.

In S160, the processor 210 determines whether a predetermined number of first-type learning image data D11 (that is, the first-type labeled data LD1) is generated. For appropriate training of the logo detection model NN1, the total number of each of the C label images included in the first-type data set DS1 is set to a large reference value (for example, 1,000) or more. When the total number of any of the C label images is less than the reference value (No in S160), the processor 210 proceeds to S125 and generates new labeled data LD1. When the total number of each of the C label images is equal to or greater than the reference value (Yes in S160), the processor 210 ends the process in FIG. 4. The generated plurality of labeled data LD1 indicate various images as illustrated in FIGS. 6A to 6H. The first-type data set DS1 includes such plurality of first-type labeled data LD1. The information processing device 200 is an example of a system that generates a plurality of first-type learning image data D11.

A5. Training Process of Logo Detection Model NN1:

FIG. 7 is a flowchart illustrating an example of a training process of the logo detection model NN1 (FIG. 3A). The logo detection model NN1 is trained such that the output data 830 indicates appropriate region information and an appropriate logo class of the logo image in the input image 800. A plurality of calculation parameters (including a plurality of calculation parameters used for calculation of each of the plurality of layers CV11 to CV1m and CN11 to CN1n) used for calculation of the logo detection model NN1 are adjusted by the training. The processor 210 executes the process in FIG. 7 in accordance with a second program 232.

In S210, the processor 210 acquires the first-type data set DS1 from the non-volatile storage device 230. In S220, the processor 210 divides the plurality of labeled data LD1 of the first-type data set DS1 into a learning data set and a confirmation data set. For example, the processor 210 adopts 70% of the randomly selected labeled data LD1 as the learning data set and adopts the remaining 30% of the labeled data LD1 as the confirmation data set. Hereinafter, it is assumed that the total number of the labeled data LD1 of the learning data set is Nt and the total number of the labeled data LD1 of the confirmation data set is Nv (both Nt and Nv are integers of 2 or more).

In S230, the processor 210 initializes a plurality of calculation parameters of the logo detection model NN1. For example, each calculation parameter is set to a random number value.

In S240, the processor 210 calculates a learning loss using the learning data set. Specifically, the processor 210 inputs Nt pieces of first-type learning image data D11 to the logo detection model NN1, and generates Nt pieces of output data 830. Then, the processor 210 calculates the learning loss using the Nt pieces of output data 830 and the Nt pieces of label data D12 associated with the Nt pieces of first-type learning image data D11.

A loss function is used to calculate the learning loss. The loss function may be various functions for calculating an evaluation value of a difference between the output data 830 and the label data D12. In the present embodiment, the loss function disclosed in the above-mentioned paper of YOLO is used. The loss function includes the following five components. That is, in relation to the bounding box which should indicate a region of the region information D121, the loss function includes three components corresponding to a difference in center position, a difference in size (that is, width and height), and a difference in certainty factor, respectively. The bounding box which should indicate the region of the region information D121 is a bounding box having the highest IOU between the region of the region information D121 and the region of the bounding box among the Bn bounding boxes associated with the cell 801 (FIG. 3B) including the center position of the region information D121. In addition, in relation to the bounding box which should not correspond to the region of the region information D121, the loss function includes a component corresponding to a difference between the certainty factor of the bounding box and an ideal certainty factor (specifically, zero). Further, in relation to the cell including the center position of the region information D121, the loss function includes a component corresponding to a difference between the C class probabilities and C correct class probabilities. The processor 210 calculates, as the learning loss, a total value of Nt losses calculated using the loss function. The learning loss may be various values correlated with the Nt losses, such as an average value or a median of the Nt losses.

In S250, the processor 210 updates the plurality of calculation parameters of the logo detection model NN1 using the learning loss. Specifically, the processor 210 adjusts the calculation parameters according to a predetermined algorithm so as to reduce the learning loss. As the predetermined algorithm, for example, an algorithm using backpropagation and gradient descent is used.

In S260, the processor 210 calculates a confirmation loss using the confirmation data set. A method for calculating the confirmation loss is the same as the method for calculating the learning loss described in S240 except that the confirmation data set is used instead of the learning data set. Specifically, the processor 210 inputs Nv pieces of first-type learning image data D11 of the confirmation data set to the logo detection model NN1 having the calculation parameters updated in S250, and generates Nv pieces of output data 830. Then, the processor 210 calculates the confirmation loss using the Nv pieces of output data 830 and Nv pieces of label data D12 associated with the Nv pieces of first-type learning image data D11.

In S270, the processor 210 determines whether the training is completed. A training completion condition may include various conditions. In the present embodiment, the training completion condition is that both the learning loss and the confirmation loss are equal to or less than a predetermined reference value. The training completion condition may include various conditions indicating that both the learning loss and the confirmation loss are small. For example, a reference value of the learning loss may be different from a reference of the confirmation loss.

When the training is not completed (No in S270), the processor 210 proceeds to S240 and continues the training. When the training is completed (Yes in S270), in S280, the processor 210 stores the logo detection model NN1 including the adjusted calculation parameters as a trained model in the storage device 215 (here, the non-volatile storage device 230). Then, the processor 210 ends the process in FIG. 7. The processor 210 may store the logo detection model NN1 in an external storage device (not illustrated) connected to the information processing device 200.

The output data 830 from the trained logo detection model NN1 has the following characteristics. A cell including the center of the logo image can indicate a bounding box that appropriately indicates the region of the logo image and has a high certainty factor and an appropriate class probability. A plurality of bounding boxes indicated by the output data 830 may include an inappropriate bounding box that does not indicate the region of the logo image. A low certainty factor is associated with the inappropriate bounding box. Accordingly, the logo image can be appropriately specified by using the bounding box having a high certainty factor.

As described above, in the generation process in FIG. 4, the processor 210 generates a plurality of first-type learning image data D11 used for the training of the logo detection model NN1 for detecting a logo that is an example of an object. Specifically, in S110, the processor 210 acquires the logo image data of the logo image which is an image of a logo. In S115 and S120, the processor 210 divides the logo image into T types of partial regions corresponding to T (T is an integer of 2 or more) partial color ranges obtained by dividing a distribution range of colors of the logo image. The processor 210 executes the adjustment process including a process of changing a color of each of one or more types of partial regions to a color different from an original color (S125). As a result, the processor 210 generates a plurality of color-changed logo image data of a plurality of color-changed logo images. Here, each of the plurality of color-changed logo images is an image of a logo. The plurality of color-changed logo images have the same type of partial region of different colors. For example, the color-changed logo images 910a and 910b in FIG. 5C have the same first-type region A1 of different colors. Then, the processor 210 generates candidate image data of the candidate image in S135 and S140. Here, the candidate image data corresponds to the learning image data D11, and the candidate image corresponds to a learning image of the learning image data D11. The processor 210 executes the processes in S125 to S140 a plurality of times. Specifically, the processor 210 generates a plurality of color-changed logo image data. Then, the processor 210 generates a plurality of candidate image data of a plurality of candidate images by using one or more background image data and a plurality of color-changed logo image data. Here, the candidate image includes a background image represented by any one or more background image data and one or more color-changed logo images arranged on the background image (FIGS. 6A to 6H). The plurality of candidate images include different color-changed logo images among the plurality of generated color-changed logo images. For example, the candidate image 800c (FIG. 6C) includes the color-changed logo image 910c that is not included in the candidate image 800f (FIG. 6F). On the other hand, the candidate image 800f includes the color-changed logo image 910b that is not included in the candidate image 800c. In this manner, the processor 210 can generate a plurality of learning image data D11 indicating images of logos represented by various colors. Such a plurality of learning image data D11 can appropriately train a machine learning model (for example, logo detection model NN1) that processes an image of a logo.

As described in S135 (FIG. 4), FIG. 6B, and the like, the one or more background image data include the background image data of the background image 800bz of a photograph. Therefore, the processor 210 can generate a plurality of learning image data D11 indicating images of logos on the background image of a photograph. Such a plurality of learning image data D11 can train a machine learning model (for example, logo detection model NN1) so as to appropriately process the images of logos on the background image of a photograph. A plurality of available background image data may include a plurality of background image data indicating photographs different from each other. The plurality of background images may include various photographs such as scenery, a person, furniture, and stationery. Such a plurality of learning image data D11 can train a machine learning model (for example, logo detection model NN1) so as to appropriately process the images of logos regardless of the content of the background image.

As described in S135 (FIG. 4), FIG. 6A, and the like, the one or more background image data include the background image data of the background image 800az indicating a monochromatic solid image. Therefore, the processor 210 can generate a plurality of learning image data indicating the images of logos on the background image indicating the monochromatic solid image. Such a plurality of learning image data D11 can train a machine learning model (for example, logo detection model NN1) so as to appropriately process the images of logos on the background image indicating the monochromatic solid image. A plurality of available background image data may include a plurality of background image data indicating solid images of different colors. Such a plurality of learning image data D11 can train a machine learning model (for example, logo detection model NN1) so as to appropriately process the images of logos regardless of the color of the background image.

It is preferable to generate a plurality of types of learning image data D11 having a plurality of types of background images indicating different contents, such as a background image of a photograph and a background image indicating a monochromatic solid image. Such a plurality of types of learning image data D11 can train a machine learning model (for example, logo detection model NN1) so as to appropriately process the images of logos on various background images.

In order to generate a plurality of color-changed logo image data, the processor 210 executes the adjustment process of the image including S125 (FIG. 4). In the embodiment in FIG. 4, the adjustment process further includes S130. S130 includes one or both of a process of changing a size of the color-changed object image and a process of changing an aspect ratio of the color-changed object image. Therefore, the processor 210 can generate learning image data D11 indicating an image of a logo of which one or both of the size and the aspect ratio are changed. Such learning image data D11 can train a machine learning model (for example, logo detection model NN1) so as to appropriately process the image of a logo of which one or both of the size and the aspect ratio are changed.

As described in S140 (FIG. 4) and FIGS. 6A to 6H, the process of generating the learning image data D11 includes a process of generating the learning image data D11 of the learning image 800a including the background image 800az and the plurality of color-changed logo images 910b, 910a2, and 910c arranged on the background image 800az. When one learning image data D11 indicates a plurality of color-changed logo images, a machine learning model (for example, logo detection model NN1) for detecting a logo image can be more efficiently trained than when one learning image data D11 indicates one color-changed logo image.

As described in S140 (FIG. 4), FIG. 6C, and the like, the process of generating the learning image data D11 includes a process of generating the learning image data D11 of the image 800c including the background image 800cz, the one or more color-changed logo images 910c arranged on the background image 800cz, and the images 920a and 920b of another logo arranged on the background image 800cz. When one learning image data D11 indicates an image of a logo and an image of another logo, a machine learning model (for example, logo detection model NN1) for detecting a logo image can be more efficiently trained than when one learning image data D11 indicates only images of the same logo.

As described in S140 (FIG. 4) and FIGS. 6A to 6H, the processor 210 arranges a plurality of logo images on one learning image such that the logo images do not overlap each other. Therefore, the learning image data D11 can appropriately train a machine learning model (for example, logo detection model NN1) for detecting a logo image.

As described in S145 (FIG. 4), the process of generating the learning image data D11 includes a process of generating the learning image data D11 by executing image processing on candidate image data of candidate images including a background image and one or more color-changed logo images arranged on the background image. Here, the image processing includes one or more processes selected from the group consisting of the above-mentioned seven processes P1 to P7. Therefore, the processor 210 can generate learning image data D11 indicating logos expressed in various formats. Such learning image data D11 can train a machine learning model (for example, logo detection model NN1) so as to appropriately process images of the logos expressed in the various formats.

A6. Configuration of Sheet Detection Model NN2:

FIG. 8A is a schematic diagram illustrating an example of a configuration of the sheet detection model NN2. In the present embodiment, the sheet detection model NN2 is a YOLO model and has the same configuration as the logo detection model NN1 (FIG. 3A). The sheet detection model NN2 includes p (p is an integer of 1 or more) convolution layers CV21 to CV2p and q (q is an integer of 1 or more) fully connected layers CN21 to CN2q following the convolution layers CV21 to CV2p (p is, for example, 24. q is, for example, 2.). A pooling layer (for example, a layer for executing max pooling) is provided immediately after one or more convolution layers among the p convolution layers CV21 to CV2p. In addition, p may be different from m in FIG. 3A. Further, q may be different from n in FIG. 3A.

FIG. 8B is an explanatory diagram illustrating an outline of an operation of the sheet detection model NN2. An image 700 is an example of an input image input to the sheet detection model NN2. Similarly to the captured images 700x and 700y in FIGS. 2A and 2B, the input image 700 is a captured image of the printer DV. The input image 700 is represented by color values of a plurality of pixels arranged in a matrix along the first direction Dx and the second direction Dy perpendicular to the first direction Dx. In the present embodiment, the color values are represented by three component values of R (red), G (green), and B (blue). In the example in FIG. 8B, the input image 700 includes an image of the sheet 910L including the first logo image 910.

The sheet detection model NN2 detects a region of an image of an object similarly to the logo detection model NN1 in FIGS. 3A and 3B. A difference from the logo detection model NN1 is that the sheet detection model NN2 is trained to detect the image of the label sheet instead of the logo image. In the present embodiment, C types of label sheets corresponding to the C types of logo images can be used. The types of the label sheets and the types of the logo images are associated with each other on a one-to-one basis. The sheet detection model NN2 detects images of the C types of label sheets. Hereinafter, the type of the label sheet is also referred to as a sheet class.

Although not illustrated, the sheet detection model NN2 detects a bounding box indicating the image of the label sheet according to the same algorithm as the algorithm of the logo detection model NN1 in FIG. 3B. In the example in FIG. 8B, a bounding box BBL indicating the seat 910L is detected. A class identifier CLL is associated with the bounding box BBL. The class identifier CLL is a class identifier corresponding to the highest class probability among the C class probabilities. The class identifier of “1” indicates a first sheet 910L.

The sheet detection model NN2 outputs output data 730 indicating S×S×(Bn×5+C) predicted values. Similarly to the output data 830 in FIG. 3A, the output data 730 indicates a region of an image of an object (here, label sheet) by the bounding box having a certainty factor equal to or greater than a threshold value. The class identifier corresponding to the highest class probability among the C class probabilities corresponding to the bounding box is adopted as a class identifier associated with the bounding box.

A7. Annotation Process (Generation Process of Second-Type Data Set DS2):

FIG. 9 is a flowchart illustrating an example of a generation process of the second-type data set DS2 (FIG. 1) for the training of the sheet detection model NN2. The second-type data set DS2 includes a plurality of second-type labeled data LD2. The second-type labeled data LD2 includes second-type learning image data D21 including an image of a label sheet and label data D22 associated with the second-type learning image data D21. Similarly to the label data D12 described in S150 and S155 of FIG. 4, the label data D22 indicates region information D221 indicating a region of a sheet image in the image and sheet class information D222 indicating a type of the sheet image. As described later, in the process in FIG. 9, the processor 210 executes a process of associating the label data D22 indicating the region information D221 and the label data D22 with the second-type learning image data D21 (this process is an example of the annotation process). The processor 210 executes the process in FIG. 9 in accordance with a third program 233.

In S310, the processor 210 acquires target image data which is image data to be processed. In the present embodiment, the processor 210 acquires unprocessed sheet image data as the target image data from a plurality of sheet image data prepared in advance. The plurality of sheet image data are stored in the storage device 215 (for example, the non-volatile storage device 230) in advance (not illustrated). Each of the plurality of sheet image data indicates an image including the label sheet. As described above, in the present embodiment, C types of label sheets corresponding to the C types of logo images can be used. The plurality of sheet image data includes C types of sheet image data indicating the C types of label sheets. FIG. 10A is an explanatory diagram illustrating an example of a target image. A target image 700a includes a region of an image of the first sheet 910L and a background region 700az. The image of the first sheet 910L includes the first logo image 910.

In the present embodiment, the sheet image data is generated by arranging an image of a sheet on a background image indicating a monochromatic solid image indicated by background image data. In an actual captured image of the printer, the background region indicates an outer surface of the printer. In the present embodiment, a color of the outer surface of the printer is the same regardless of the position. Therefore, even in the actual captured image, an image of the background region is approximately a monochromatic solid image. The background image is not limited to a monochromatic solid image, and may be various images such as a captured image of the outer surface of the printer. In addition, the plurality of sheet image data may be generated by capturing a printer having a label sheet with a digital camera.

In S315 (FIG. 9), the processor 210 specifies the logo region by analyzing the target image data using the logo detection model NN1 (FIG. 3A). Specifically, the processor 210 generates the output data 830 by inputting the target image data to the logo detection model NN1. The processor 210 adopts a rectangular region surrounded by a bounding box (specifically, a bounding box having a certainty factor equal to or greater than a predetermined threshold) indicated by the output data 830 as a logo region. FIG. 10B is an explanatory diagram illustrating an example of the logo region. A bounding box BBt indicates the first logo image 910 on the target image 700a. The processor 210 specifies a region surrounded by the bounding box BBt as a logo region LA. In addition, the processor 210 specifies a class identifier associated with the highest class probability among C class probabilities associated with the bounding box BBt as a logo class CLt indicating a type of the logo region LA (in the example in FIG. 10B, CLt=1).

In S320 (FIG. 9), the processor 210 determines whether a logo region is detected. When the logo region is detected (Yes in S320), the processor 210 determines an extended region including the logo region in S325.

FIG. 11 is a flowchart illustrating an example of a process of determining candidates of the extended region. In S410, the processor 210 divides a target image into a plurality of blocks. FIG. 10C is an explanatory diagram illustrating an example of the plurality of blocks. The target image 700a is divided into a plurality of blocks BL having a predetermined shape. An arrangement of the plurality of blocks BL in the target image 700a is determined in advance.

In S420 (FIG. 11), the processor 210 calculates an edge intensity value of each of the plurality of blocks BL. The edge intensity value is an evaluation value of a ratio of change in color to change in position on the target image. In the present embodiment, the processor 210 calculates an edge amount (for example, an absolute value of a calculation result by a filter) of each pixel using a so-called Laplacian filter. A predetermined color component (for example, luminance value) is used to calculate the edge amount. Then, the processor 210 calculates an average value of edge amounts of a plurality of pixels in the blocks BL as the edge intensity value of the blocks BL. The edge intensity value may be calculated by various other methods. For example, the filter may be any filter for calculating the edge amount (such as a Sobel filter or a PreWitt filter) instead of the Laplacian filter. The edge intensity value of the blocks BL may be various values correlated with the edge amounts of the plurality of pixels, such as a median and a mode value, instead of the average value of the edge amounts of the plurality of pixels.

In S430, the processor 210 specifies a block BL having an edge intensity value equal to or less than a predetermined reference as a uniform block. Hereinafter, a block BL different from the uniform block among the plurality of blocks BL is also referred to as a non-uniform block.

FIG. 10D is an explanatory diagram illustrating an example of the uniform block. Among the plurality of blocks BL in the target image 700a, a hatched block BL1 is a uniform block BL1, and a non-hatched block BL2 is a non-uniform block BL2. As illustrated, a plurality of blocks BL of the background region 700az on an outer side of the first sheet 910L are uniform blocks BL1. A large number of blocks BL among the plurality of blocks BL indicating the first sheet 910L are non-uniform blocks BL2. Some of the plurality of blocks BL indicating the first sheet 910L are uniform blocks BL1. Generally, the label sheet may include other elements such as characters, graphics, marks, and symbols in addition to the logo image. Therefore, a ratio of the uniform blocks BL1 among the plurality of blocks BL indicating the label sheet 910L is small. Pixels indicating a contour 910Lo of the label sheet 910L have a large edge amount. Therefore, the blocks BL indicating the contour 910Lo of the label sheet 910L is likely to be the non-uniform blocks BL2.

In S440 (FIG. 11), the processor 210 adopts a region the same as the logo region as an initial region of the extended region. Then, the processor 210 moves the contour of the extended region toward the outer side of the logo region, thereby determining the candidates of the extended region including the logo region. The processor 210 moves the contour such that the entire contour is included in the uniform blocks BL1. FIG. 10E is an explanatory diagram illustrating an example of the candidates for the extended region. A candidate extended region LAe on the target image 700a includes the logo region LA and a portion on the outer side of the logo region LA. The entire of a contour LAeo of the candidate extended region LAe is included in the uniform block BL1. As described above, the blocks BL indicating the contour 910Lo of the label sheet 910L is likely to be the non-uniform blocks BL2. Therefore, the processor 210 can determine the candidate extended region LAe having the contour LAeo surrounding the contour 910Lo of the label sheet 910L from the outer side. The candidate extended region LAe includes the entire of the label sheet 910L.

A process of moving the contour may be various processes. In the present embodiment, the contour LAo of the logo region LA is constituted by four sides (that is, an upper side, a lower side, a left side, and a right side) forming a rectangle. The processor 210 repeats a process of sequentially moving the four sides toward the outer side by a predetermined amount until all of the four sides are included in the uniform blocks BL1. As a result, the processor 210 can determine the candidate extended region LAe which includes the entire of the label sheet 910L and is smaller than the target image 700a.

In response to completion of S440, the processor 210 ends the process in FIG. 11, that is, S325 in FIG. 9.

In S330, the processor 210 selects candidate sheet class information which is a candidate of sheet class information from the C pieces of sheet class information based on the logo class specified in S315. In the present embodiment, when the logo class specified in S315 corresponds to any of the two logo images 910 and 920, the processor 210 adopts two sheet class information corresponding to the two logo images 910 and 920 as candidates. In the present embodiment, C types of available logo images include a third logo image (not illustrated). When the logo class specified in S315 corresponds to the third logo image, the processor 210 adopts one sheet class information corresponding to the third logo image as a candidate. A correspondence relation between the logo class specified in S315 and the candidate sheet class information is determined in advance. As the candidate sheet class information, sheet class information that can be appropriate in view of the logo class specified in S315 is adopted. The processor 210 selects a candidate associated with the logo class.

In S335, the processor 210 displays a user interface screen (also referred to as a UI screen) on the display 240 (FIG. 1). FIG. 12A is an explanatory diagram illustrating an example of the UI screen. A UI screen 600 includes a first user interface image 610 and a second user interface image 620. The UI screen 600 shows an example in which the number of candidate sheet class information selected in S330 (FIG. 9) is two or more.

The first user interface image 610 is a user interface image for causing the user to change a position of the contour LAeo of the candidate extended region LAe. The first user interface image 610 indicates the target image 700a including the first sheet 910L and the contour LAeo of the candidate extended region LAe. The user can move the contour LAeo by operating the operation unit 250 (FIG. 1).

The second user interface image 620 is a user interface image for allowing the user to specify sheet class information indicating classification of the candidate extended region LAe (that is, classification of the label sheet). The second user interface image 620 indicates a candidate region 621 indicating one or more candidates of the sheet class information selectable by the user, and a check box 622 indicating one candidate selected from the one or more candidates. A solid check box 622 indicates a selectable candidate, and a broken check box 622 indicates an unselectable candidate. The selectable candidate is the candidate selected in S330.

In the example in FIG. 12A, the second user interface image 620 indicates four sheet class information CC1, CC2, CC3, and CC4. A first sheet class information CC1 corresponds to the first logo image 910 (FIG. 3B), a second sheet class information CC2 corresponds to the second logo image 920, a third sheet class information CC3 corresponds to the third logo image (not illustrated), and a fourth sheet class information CC4 indicates a barcode. The two of sheet class information CC1 and CC2 are selectable, and the other sheet class information CC3 and CC4 are unselectable. The user can check (that is, select) one of the one or more selectable candidates by operating the operation unit 250 (FIG. 1). In S335 (FIG. 9), the processor 210 adopts the sheet class information corresponding to the logo class specified in S315 as default sheet class information. Then, the processor 210 displays the second user interface image 620 in a state where the default sheet class information is selected.

FIG. 12C illustrates an example of the UI screen when the number of candidate sheet class information selected in S330 (FIG. 9) is 1. The first user interface image 610 indicates a target image 700c including the image of a label sheet 930L. The label sheet 930L includes a third logo image 930. The second user interface image 620 indicates that the third sheet class information CC3 is selectable and the other sheet class information CC1, CC2, and CC4 are unselectable.

In the second user interface image 620, display of the unselectable candidates may be omitted.

In S340 (FIG. 9), the processor 210 receives a change in position of the contour LAeo by the user. FIG. 12B is an explanatory diagram illustrating an example of the changed contour LAeo. In the example in FIG. 12B, the user brings each of the four sides of the contour LAeo close to the contour 910Lo of the label sheet 910L. As a result, the candidate extended region LAe can appropriately indicate the region of the label sheet 910L. When the position of the contour LAeo is changed by the user, the processor 210 determines a region having the contour at the changed position as a final extended region. The user can input an instruction to accept the position of the contour LAeo without changing the position of the contour LAeo by operating the operation unit 250. In this case, the processor 210 determines the candidate extended region LAe determined in S325 as the final extended region.

In S345 (FIG. 9), the processor 210 determines whether the total number of selectable candidates of the sheet class information is 1. When the number of selectable candidates is greater than 1 (No in S345), in S355, the processor 210 receives a designation of sheet class information by the user. In examples in FIGS. 12A and 12B, the user can select one of the two sheet class information CC1 and CC2 by operating the operation unit 250 (FIG. 1). For example, the logo class specified in S315 (FIG. 9) may be an error. That is, the default sheet class information adopted in S335 may be an error. The user can confirm appropriate sheet class information by observing the label sheet displayed in the first user interface image 610. The user can designate the appropriate sheet class information by operating the operation unit 250. When the default sheet class information is correct, the user can input an instruction to accept the default sheet class information by operating the operation unit 250. After S355, the processor 210 proceeds to S360.

When the total number of the selectable candidates of the sheet class information is 1 (Yes in S345), in S350, the processor 210 determines the sheet class information as the candidate sheet class specified in S330. Then, the processor 210 proceeds to S360.

In S360, the processor 210 generates annotation data indicating annotation information including region information indicating the candidate extended region LAe and the sheet class information determined in S350 or S355. In S365, the processor 210 stores the target image data and the annotation data in the storage device 215 (for example, the non-volatile storage device 230) in association with each other. The entire of the target image data and the annotation data associated with each other forms the second-type labeled data LD2 (FIG. 1). The target image data corresponds to the second-type learning image data D21, and the annotation data corresponds to the label data D22. The processor 210 may store the labeled data LD2 in an external storage device (not illustrated) connected to the information processing device 200.

After S365, the processor 210 proceeds to S370. When no logo region is detected in S315 (No in S320), the processor 210 skips S325 to S365 and proceeds to S370. In S370, the processor 210 determines whether the process of all the sheet image data is completed. When unprocessed sheet image data remains (No in S370), the processor 210 proceeds to S310 and executes processing of new target image data. When the processing of all the sheet image data is completed (Yes in S370), the processor 210 ends the process in FIG. 9. As a result, the second-type data set DS2 is generated. The information processing device 200 is an example of a system that associates the label data D22 with the second-type learning image data D21.

A8. Training Process of Sheet Detection Model NN2:

FIG. 13 is a flowchart illustrating an example of a training process of the sheet detection model NN2 (FIG. 8A). The sheet detection model NN2 is trained such that the output data 730 indicates appropriate region information and appropriate sheet class information of the image of the label sheet in the input image 700. A plurality of calculation parameters (including a plurality of calculation parameters used for calculation of each of the plurality of layers CV21 to CV2p and CN21 to CN2q) used for calculation of the sheet detection model NN2 are adjusted by the training. The processor 210 executes the process in FIG. 13 in accordance with a fourth program 234.

The training process in FIG. 13 is the same as the training process in FIG. 7 except that the model to be trained is the sheet detection model NN2 and the data set used for the training is the second-type data set DS2. S510 to S580 in FIG. 13 are the same as S210 to S280 in FIG. 7 (detailed explanations are omitted). The output data 730 from the trained sheet detection model NN2 can appropriately indicate the region of the image of the label sheet and indicate the bounding box having a high certainty factor and an appropriate class probability. In S580, the processor 210 may store the sheet detection model NN2 in the storage device 215, or alternatively, may store the sheet detection model NN2 in an external storage device (not illustrated) connected to the information processing device 200.

The trained sheet detection model NN2 (FIG. 8A) can be used for inspecting the printer. The processor 210 inputs captured image data (for example, the captured images illustrated in FIGS. 2A and 2B) of the printer to the sheet detection model NN2. The output data 730 output from the sheet detection model NN2 indicates the region of the label sheet detected from the captured image. When the label sheet is detected, an inspection result of the printer is acceptable. When no label sheet is detected, the inspection result of the printer is unacceptable.

As described above, in the process in FIG. 9, the processor 210 executes a process of associating information with the second-type learning image data D21 used for the training of the sheet detection model NN2 which is an example of the machine learning model. Specifically, in S310, the processor 210 acquires the target image data (that is, the second-type learning image data D21) of the target image (for example, the target image 700a (FIG. 10A)) which is an image to be processed. In S315, the processor 210 analyzes the target image data to detect the logo region (for example, the logo region LA) indicating an image of a logo, which is an example of an object of interest, from the target image. In S325 and S340, the processor 210 determines the candidate extended region LAe including the logo region and a portion on the outer side of the logo region. In S360 and S365, the processor 210 stores the annotation data (that is, the label data D22) indicating the annotation information including region information indicating the extended region LAe in the storage device 215 in association with the target image data. In this manner, the processor 210 can associate the region information indicating the candidate extended region LAe including another region in addition to the region LA indicating the logo with the second-type learning image data D21. For example, as illustrated in FIGS. 12A and 12B, the processor 210 can associate the region information D221 indicating the region of the label sheet 910L including the logo image 910 and another image with the second-type learning image data D21. Such region information D221 is suitable for training of a machine learning model (for example, the sheet detection model NN2) that processes a region (for example, the region of the label sheet) including another region in addition to the region indicating a logo.

As described in S310 (FIG. 9), FIG. 10A, and the like, the image of the object of interest is a logo image. Therefore, the processor 210 can associate the region information D221 indicating the extended region including another region in addition to the region indicating the logo image with the second-type learning image data D21.

As illustrated in FIG. 10B and the like, the region detected in S315 (FIG. 9) is a rectangular region. To detect the rectangular region indicating the image (for example, a logo image) of the object of interest, not only YOLO but also various object detection models can be used (for example, a single shot multibox detector (SSD), region based convolutional neural networks (R-CNN), and the like). Therefore, the processor 210 can appropriately detect the region.

A process of determining the extended region includes S325 (FIG. 9). S325, that is, the process in FIG. 11 includes a process of extending the extended region from the same region as the logo region LA toward the outer side of the logo region LA by analyzing the target image data as illustrated in FIG. 10E and the like. In the present embodiment, this process is executed by the processor 210. Through this process, candidates for the extended region LAe are determined. In this manner, the processor 210 (that is, the information processing device 200) extends the extended region LAe, and thus the information processing device 200 can reduce a burden on the user.

In addition, S325, that is, the process in FIG. 11 includes the processes of S410 to S430 and the process of S440. As illustrated in FIG. 10D and the like, in the processes of S410 to S430, the processor 210 analyzes the target image data to specify the block BL having the edge intensity value equal to or less than the reference as the uniform block BL1. The edge intensity value is an evaluation value of a ratio of change in color to change in position on the target image. A condition (also referred to as a uniform condition) for selecting the block BL as the uniform block BL1 indicates that the edge intensity value is equal to or less than the reference. In addition, as illustrated in FIG. 10E and the like, in S440, the processor 210 extends the extended region toward the outer side of the logo region LA such that the entire of the contour LAeo of the extended region LAe is included in the uniform block BL1. In this manner, the processor 210 can appropriately extend the extended region LAe using the uniform block BL1. For example, the extended region LAe can be extended to a boundary between the background region and a region of a large object (for example, the label sheet 910L) including the object of interest (here, the logo image 910) and other elements. The region LAe extended in such a manner is suitable for training of a machine learning model (for example, the sheet detection model NN2) that processes a region of the large object including another region in addition to the region indicating a logo.

The process of determining the extended region LAe includes S335 and S340 (FIG. 9). In S335, as illustrated in FIGS. 12A and 12B, the processor 210 displays the first user interface image 610 for causing the user to change the position of the contour LAeo of the candidate extended region LAe on the display 240. In S340, the processor 210 determines a region having a contour at the position changed by the user as the extended region. Therefore, the processor 210 can determine an appropriate extended region using the contour changed by the user.

When S355 (FIG. 9) is executed, in S335, as illustrated in FIG. 12A and the like, the processor 210 displays the second user interface image 620 for causing the user to specify the sheet class information indicating the classification of the extended region LAe (that is, the classification of the label sheet) on the display 240. In S360 and S365, the processor 210 stores the annotation data indicating the annotation information including the sheet class information specified by the user in the storage device 215 in association with the target image data. Therefore, the processor 210 can associate appropriate sheet class information with the target image data.

As illustrated in FIGS. 12A and 12C and the like, the second user interface image 620 includes the candidate region 621 indicating one or more candidates of the sheet class information selectable by the user. As described in S330, the candidate region 621 indicates, as the one or more candidates, one or more sheet class information associated in advance with the logo included in the logo region detected in S315 among the predetermined C pieces of sheet class information. For example, when the first logo image 910 (FIG. 12A) is detected, the sheet class information CC1 and CC2 associated with the first logo image 910 are candidates. Therefore, the user can easily select appropriate sheet class information.

When S350 (FIG. 9) is executed, in S350, the processor 210 determines candidate sheet class information associated in advance with the logo included in the logo region detected in S315 among the predetermined C pieces of sheet class information as sheet class information to be included in the annotation information. For example, when the third logo image 930 (FIG. 12C) is detected, in S330, the processor 210 selects the third sheet class information CC3 associated with the third logo image 930 as a candidate. In S350, the processor 210 determines the third sheet class information CC3 as the sheet class information to be included in the annotation information. In S360 and S365, the processor 210 stores the annotation data indicating the annotation information including the determined sheet class information in the storage device 215 in association with the target image data. Therefore, the processor 210 can associate appropriate sheet class information with the target image data.

### B. MODIFICATION

(1) The process of generating learning image data for training of an object detection model may be various other processes instead of the process in FIG. 4. For example, the process of dividing the logo image into T types of partial regions (S115 to S120) may be a process of dividing the logo image according to a predetermined region pattern (for example, a region pattern indicating the first-type region A1 and the second-type region A2) without analyzing a color distribution of the logo image data.

In S125, the color after change may be various colors. For example, the color after change may be a predetermined color different from the original color. In addition, when the color of the logo image is expressed using halftone dots, the color after change may be a color expressed using halftone dots different from the original halftone dots (for example, the number of lines being different from the original number of lines).

The background image available in S135 to S140 is not limited to a monochromatic solid image and a photograph, and may be various images such as a graphic and a pattern. Any one or both of the photograph and the monochromatic solid image may be omitted from the available background image.

In S130, any one of the size change process and the aspect ratio change process may be omitted. Further, S130 may be omitted.

In each of one or more processes among S125, S130, S135, S140, and S145, the processor 210 may determine a process content in accordance with a predetermined plan instead of randomly determining the process content.

The number C of types of the logo image (that is, the number C of classifications (classes)) is not limited to three, and may be one or more of various numbers such as one, two, or four.

In S140, a plurality of logo images may be arranged so as to partially overlap each other. In addition, a part of the logo image may be deleted.

In S145, one or more processes optionally selected from the above-mentioned seven processes P1 to P7 may be omitted from the available processes. In addition, S145 may be omitted.

The machine learning model for detecting the logo image is not limited to the YOLO model illustrated in FIG. 3A, and may be an improved YOLO model such as a “YOLO v3”. Other models such as SSD, R-CNN, Fast R-CNN, Faster R-CNN, and Mask R-CNN may be used.

An object to be detected by the object detection model is not limited to an image of a logo, and may be any object (for example, a component mounted to a printer, a barcode, or the like). The first-type data set DS1 generated in the process in FIG. 4 (or the process of the modification) may be used for training of various object detection models.
(2) The process of associating information with image data used for training of a machine learning model may be various other processes instead of the process in FIG. 9. For example, the process of detecting the logo region (S315) may be various other processes instead of the process using the logo detection model NN1. For example, the processor 210 may detect the logo region by pattern matching using reference logo image data indicating a reference logo image.

The process of determining an extended region may be various other processes instead of the processes of S325 and S340. For example, the processor 210 may determine the extended region using one template image indicating a logo region and the extended region associated with the logo region. Specifically, the processor 210 determines a position of the template image with respect to a target image such that a logo region in the target image matches the logo region in the template image. Then, the processor 210 determines the extended region indicated by the template image at the determined position as the extended region to be applied to the target image.

The object of interest used to determine the extended region is not limited to a logo image, and may be any object such as a barcode. The shape of an object region (for example, the logo region) indicating an image of the object of interest may be any other shape instead of the rectangular shape. For example, the shape of the object region may be a polygonal shape such as a triangular shape, a pentagonal shape, or a hexagonal shape, or may be a shape determined by a contour including a curved portion such as a circle or an ellipse. In addition, the shape of the object region may be determined by the contour of the object.

The process of specifying a uniform region on the target image may be various other processes instead of the processes of S410 to S430 in FIG. 11. Here, the uniform region is a region that satisfies a uniform condition. The uniform condition is a condition indicating that a ratio of a change in color to a change in position on the target image is equal to or less than a reference. For example, the edge intensity value of the block BL may be various values indicating the ratio of the change in color to the change in position. The edge intensity value may be, for example, a difference between a maximum luminance value and a minimum luminance value in the block BL. The processor 210 may specify the uniform region using a histogram of color values (for example, luminance values) of a plurality of pixels of the target image. Specifically, the processor 210 may specify one continuous region formed by a plurality of pixels included in one section of the histogram as one uniform region. In this case, the uniform condition is that the color values are included in one section.

In the examples in FIGS. 12A to 12C, one UI screen 600 shows the first user interface image 610 and the second user interface image 620. That is, the process of displaying the UI screen 600 on the display 240 includes a process of displaying the first user interface image 610 and a process of displaying the second user interface image 620. Alternatively, the processor 210 may display the first user interface image 610 on a screen different from a screen displaying the second user interface image 620.

S340 in FIG. 9 may be omitted. In this case, the processor 210 may directly determine the candidate extended region determined in S325 as the final extended region. In addition, the first user interface image 610 may be omitted from the UI screen (FIGS. 12A to 12C).

S350 in FIG. 9 may be omitted. For example, the processor 210 may select a plurality of candidate sheet class information in S330 regardless of the logo class specified in S315, and may receive a designation of sheet class information by the user in S355. In addition, S355 may be omitted. For example, the processor 210 may select one candidate sheet class information associated with the logo class in S330 regardless of the logo class specified in S315, and may determine sheet class information as the candidate sheet class specified in S330 in S350. Further, the sheet class information may be omitted from the annotation information. For example, when the number C of types of label sheets is 1, appropriate training using the second-type data set DS2 is possible even when the sheet class information is omitted.

The machine learning model for detecting the image of the label sheet is not limited to the YOLO model illustrated in FIG. 8A, and may be other models such as YOLO v3, SSD, R-CNN, Fast R-CNN, Faster R-CNN, Mask R-CNN, and the like.
(3) An inspection target using a machine learning model is not limited to a printer, and may be any product such as a scanner, a multi function device, a digital camera, a cutting machine, or a mobile terminal. In addition, a case for accommodating a product may be the inspection target. The machine learning model may be trained to detect various other objects, not limited to a label sheet. For example, the machine learning model may detect a component to be mounted on the printer from a captured image of the printer. In either case, when an image of an object to be detected (for example, a label sheet) includes an image of a small characteristic portion (for example, a logo), an extended region including the characteristic portion can be used as a region indicating the object to be detected. Annotation information including region information indicating such an extended region may be associated with image data for training. Such image data and annotation information may be used for training of various machine learning models such as a classification model, not limited to an object detection model.
(4) A color space of input image data input to the machine learning model may be another color space such as a CMYK color space instead of the RGB. The input image data may express an image by luminance values. In addition, the input image data may be generated by executing various kinds of image processing such as a resolution conversion process and a trimming process.
(5) The method for associating image data with label data may be any method. For example, the label data may include identification data for identifying the image data associated with the label data. The processor 210 may generate table data indicating a correspondence relation between the image data and the label data. In addition, the processor 210 may store the image data and the label data associated with each other in one data file.
(6) The training process of the machine learning model may use various methods suitable for the machine learning model, instead of the processes in FIGS. 7 and 13. For example, in the examples in FIGS. 7 and 13, a loss function used for calculating a loss may be various functions for calculating an evaluation value of a difference between the output data 730 and 830 and the label data, such as a cross entropy error. For example, when an object detection model is used, the loss function may be various functions for calculating a loss having a correlation between an error of a region indicating an object and an error of a probability for each type of object.

In addition, the method for adjusting calculation parameters included in the machine learning model may be various other methods such as a method for propagating a target value (also referred to as target propagation) instead of the backpropagation. The training completion condition may be various conditions indicating that a difference between data output from the machine learning model and the label data is small. For example, the confirmation loss may be omitted from the training completion condition. In this case, in the processes in FIGS. 7 and 13, all labeled data may be used as the learning data set. The processor 210 may determine that the training is completed when a completion instruction is input by the operator, and may determine that the training is not completed when a continuation instruction of the training is input. For example, the operator may determine whether to end the training by referring to output data output using the confirmation data set. Alternatively, the training completion condition may be that the calculation of the learning loss and the update of the calculation parameters (for example, S240 to S250 (FIG. 7) and S540 to S550 (FIG. 13)) are repeated a predetermined number of times.
(7) The generation process of the data set in FIG. 4, the training process in FIG. 7, the annotation process (generation process of the data set) in FIG. 9, the training process in FIG. 13, and an inspection process (not illustrated) may be executed by different information processing devices. Processes optionally selected from these processes may be assigned to a plurality of devices (for example, information processing devices such as computers) capable of communicating with each other via a network.

In each of the above-mentioned embodiments, a part of the configuration implemented by hardware may be replaced with software, or a part or all of the configuration implemented by software may be replaced with hardware. For example, functions of each of the models NN1 and NN2 in FIG. 1 may be realized by a dedicated hardware circuit.

When some or all of functions of the present invention are realized by a computer program, the program can be provided in a form of being stored in a computer-readable recording medium (for example, a non-transitory recording medium). The program can be used in a state of being stored in a recording medium (computer-readable recording medium) that is the same as or different from that at the time of provision. The “computer-readable recording medium” is not limited to a portable recording medium such as a memory card or a CD-ROM, and may include an internal storage device in a computer such as various ROMs and an external storage device connected to a computer such as a hard disk drive.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. An association method of associating information with image data used for training of a machine learning model, the association method comprising:
acquiring target image data of a target image which is an image to be processed;
analyzing the target image data to detect an object region indicating an image of an object of interest from within the target image;
determining an extended region including the object region and a portion on an outer side of the object region; and
associating annotation data, which indicates annotation information including region information indicating the extended region, with the target image data to be stored in a storage device.

2. The association method according to claim 1,
wherein the image of the object of interest is a logo image.

3. The association method according to claim 1, wherein
the object region is a rectangular region.

4. The association method according to claim 1,
wherein the determining includes causing an information processing device to analyze the target image data to extend the extended region from the same region as the object region toward the outer side of the object region.

5. The association method according to claim 4,
wherein the causing the information processing device to analyze the target image data includes causing the information processing device to perform:
analyzing the target image data to specify a uniform region that is a region satisfying a uniform condition indicating that a ratio of a change in color with respect to a change in position on the target image is equal to or less than a reference; and
extending the extended region toward the outer side of the object region such that the entire contour of the extended region is included in the uniform region.

6. The association method according to claim 1,
wherein the determining includes:
displaying, on a display device, a first user interface image for causing a user to change a position of the contour of the extended region; and
determining a region having a contour at a position changed by the user as the extended region.

7. The association method according to claim 1, further comprising:
displaying, on a display device, a second user interface image for allowing a user to specify class information indicating classification of the extended region,
wherein the annotation data indicating the annotation information including the class information specified by the user is associated with the target image data to be stored in the storage device.

8. The association method according to claim 7,
wherein the second user interface image includes a candidate region indicating one or more candidates of class information selectable by the user, and
the candidate region indicates one or more class information associated in advance with the object of interest included in the detected object region among a plurality of predetermined class information as the one or more candidates.

9. The association method according to claim 1,
wherein the annotation data indicating the annotation information including class information associated in advance with the object of interest included in the detected object region among a plurality of predetermined class information is associated with the target image data to be stored in the storage device.

10. An association system that associates information with image data used for training of a machine learning model, the association system comprising a processor configured to:
acquire target image data of a target image which is an image to be processed;
analyze the target image data to detect an object region indicating an image of an object of interest from within the target image;
determine an extended region including the object region and a portion on an outer side of the object region; and
associate annotation data, which indicates annotation information including region information indicating the extended region, with the target image data to be stored in a storage device.

11. A non-transitory computer-readable storage medium storing a computer program executable by a computer that associates information with image data used for training of a machine learning model, the computer program comprising instructions that, when executed by the computer, cause the computer to perform:
acquiring target image data of a target image which is an image to be processed;
analyzing the target image data to detect an object region indicating an image of an object of interest from within the target image;
determining an extended region including the object region and a portion on an outer side of the object region; and
associating annotation data, which indicates annotation information including region information indicating the extended region, with the target image data to be stored in a storage device.
